(19) United States
(12) Patent Application Publication
(10) Pub. No.: US 2015/0104769 A1
(43) Pub. Date: Apr. 16, 2015

(54) LOCATION-BASED INCENTIVES IN EDUCATION

(71) Applicant: Eric Kades, Radnor, PA (US)

(72) Inventor: Eric Kades, Radnor, PA (US)

(21) Appl. No.: 14/491,839

(22) Filed: Sep. 19, 2014

Related U.S. Application Data
(60) Provisional application No. 61/880,725, filed on Sep. 20, 2013.

(51) Int. Cl. G09B 5/08

(52) U.S. Cl. CPC G09B 5/08
USPC 434/236

(57) ABSTRACT

The present disclosure is directed to methods and systems for providing incentives for students to participate in educational opportunities.

### CROSS REFERENCE TO RELATED APPLICATION

This application claims the benefit of U.S. Provisional Application No. 61/880,725, filed Sep. 20, 2013, the disclosure of which is incorporated by reference herein in its entirety.

### FIELD

The present disclosure is directed to methods and systems for providing incentives for students to participate in educational opportunities.

### BRIEF DESCRIPTION OF THE FIGURES

FIG. 1 illustrates a screenshot of a software application as described herein.

FIG. 2 illustrates a chart showing ownership of smartphones by demographics.

FIG. 3 illustrates a screenshot of a software application on a smartphone.

FIG. 4 illustrates a screenshot of a software application on a smartphone.

FIG. 5 illustrates a screenshot of a software application on a smartphone.

FIG. 6 illustrates a screenshot of a software application on a smartphone.

FIG. 7 illustrates an exemplary student life cycle from college acceptance through graduation and beyond.

FIG. 8 illustrates a screenshot of a software application on a smartphone.

FIG. 9 illustrates a screenshot of a software application on a smartphone.

FIG. 10 illustrates iBeacons ranging technology.

### DETAILED DESCRIPTION

For purposes of this description, certain aspects, advantages, and novel features of the embodiments of this disclosure are described herein. The disclosed methods, apparatuses, and systems should not be construed as limiting in any way. Instead, the present disclosure is directed toward all novel and nonobvious features and aspects of the various disclosed embodiments, alone and in various combinations and sub-combinations with one another. The methods, apparatus, and systems are not limited to any specific aspect or feature or combination thereof, nor do the disclosed embodiments require that any one or more specific advantages be present or problems be solved.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods. Additionally, the description sometimes uses terms like “provide” or “achieve” to describe the disclosed methods. These terms are high-level abstractions of the actual operations that are performed. The actual operations that correspond to these terms may vary depending on the particular implementation and are readily discernible by one of ordinary skill in the art.

As used in this application and in the claims, the singular forms “a,” “an,” and “the” include the plural forms unless the context clearly dictates otherwise. Additionally, the term “includes” means “comprises.” Further, the terms “coupled” and “associated” generally mean electrically, electromagnetically, and/or physically (e.g., mechanically or chemically) coupled or linked and does not exclude the presence of intermediate elements between the coupled or associated items absent specific contrary language.

The novel systems and methods described herein provide various incentives for students to participate in educational opportunities. For example, some embodiments provide opportunities for students to receive rewards based on their physical presence at various related locations (e.g., campus and/or other educational facilities). These systems can improve the participating of students in education and educational activities, thereby, among other things, improving the likelihood that participating students will succeed at the education institution.

### EXAMPLES

The attached examples and embodiments illustrate various implementations of the methods and systems described herein.

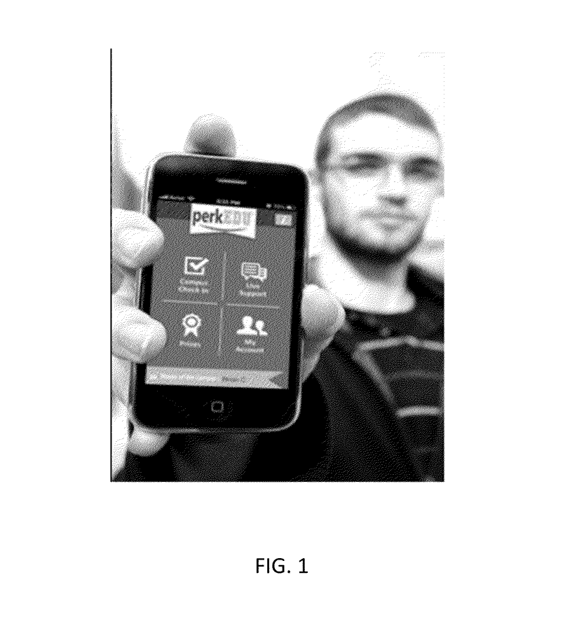

FIG. 1 illustrates a screenshot of a software application on a smartphone.

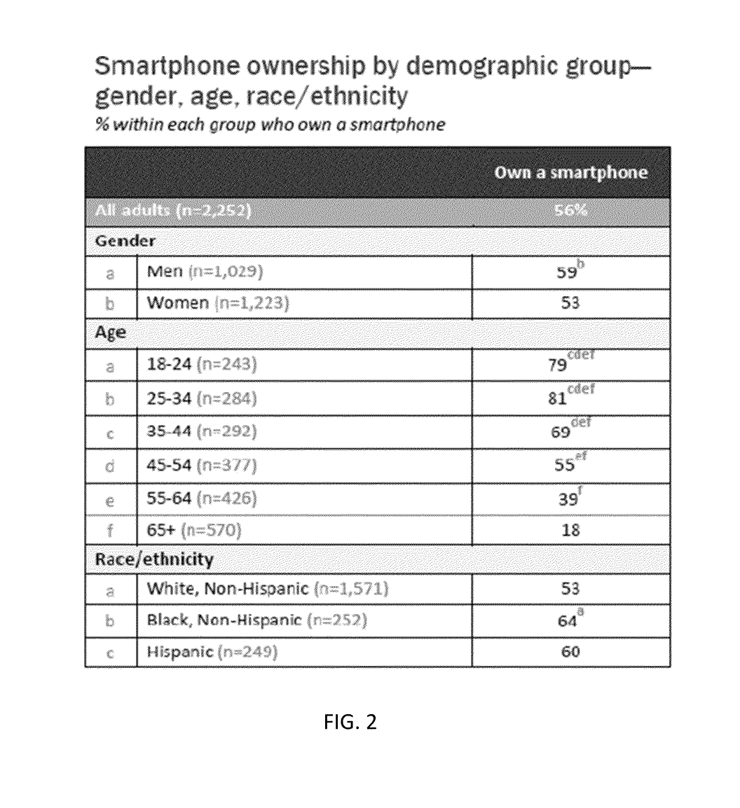

FIG. 2 illustrates a chart showing ownership of smartphones by demographics. According to the Pew Foundation, 31 percent own an iPhone, while 43% own an Android device. According to CCN.com, Americans 18-29 send and receive an average of nearly 88 text messages per day, compared to 17 phone calls. More than 2 trillion SMS messages were sent in the US in 2011, according to Forrester Research.

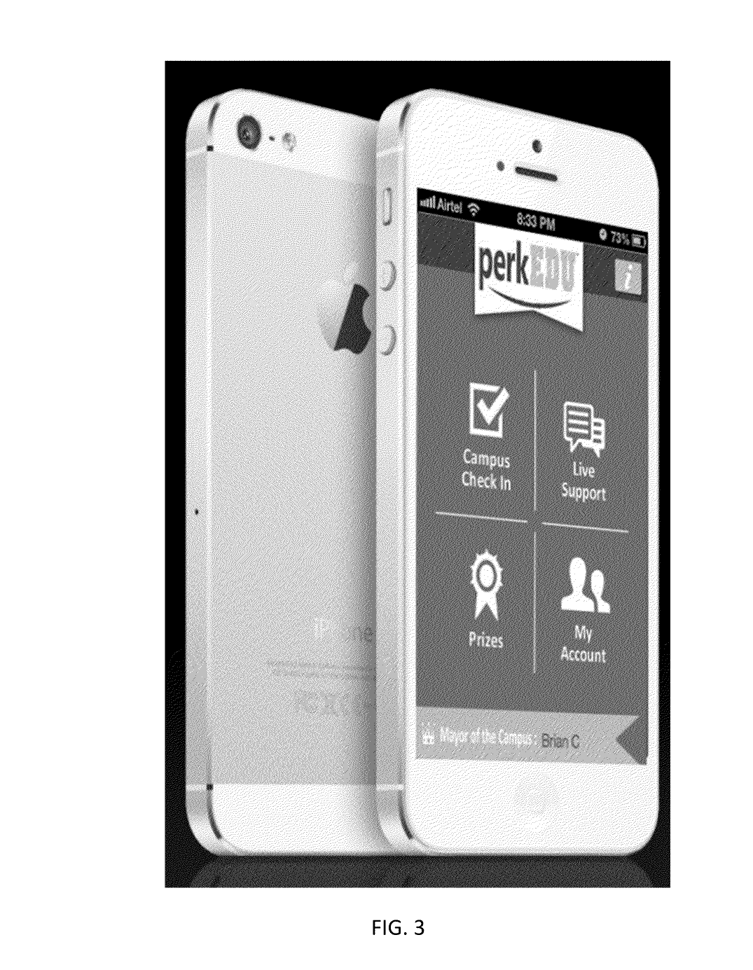

FIG. 3 illustrates a screenshot of a software application on a smartphone. The application shown in FIG. 3 permits frequent communication, increased student engagement, incentivized positive reinforcement, motivational push messaging, and student follow up, all of which result in higher graduation rates.

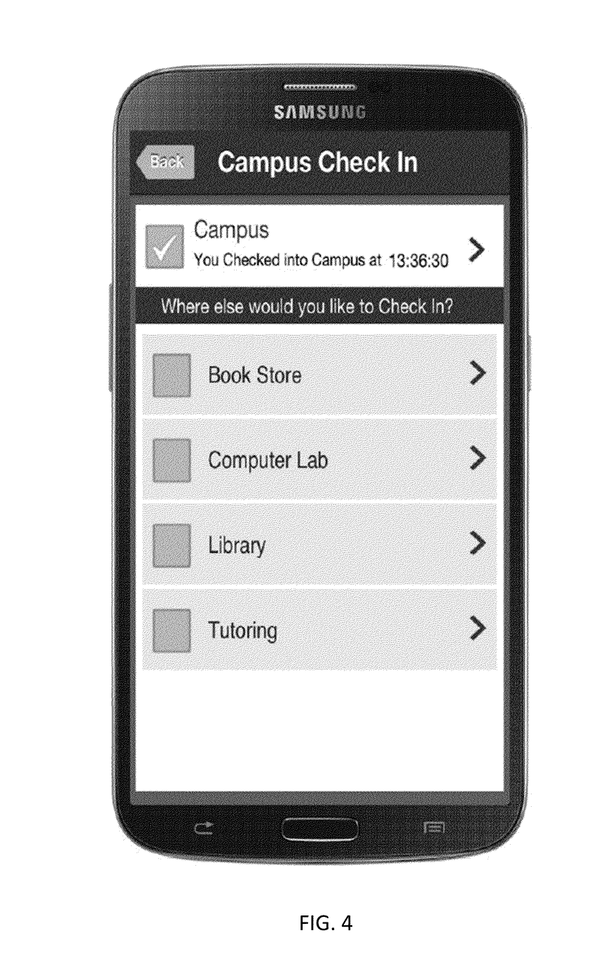

FIG. 4 illustrates a screenshot of a software application on a smartphone. Campus check in can be used, for example, when (1) entering campus, (2) at counseling office, (3) at tutoring, (4) at faculty office hours, (5) special program offices (EOPS, DSPS, etc.), (6) classroom, (7) athletic events, and (8) at library.

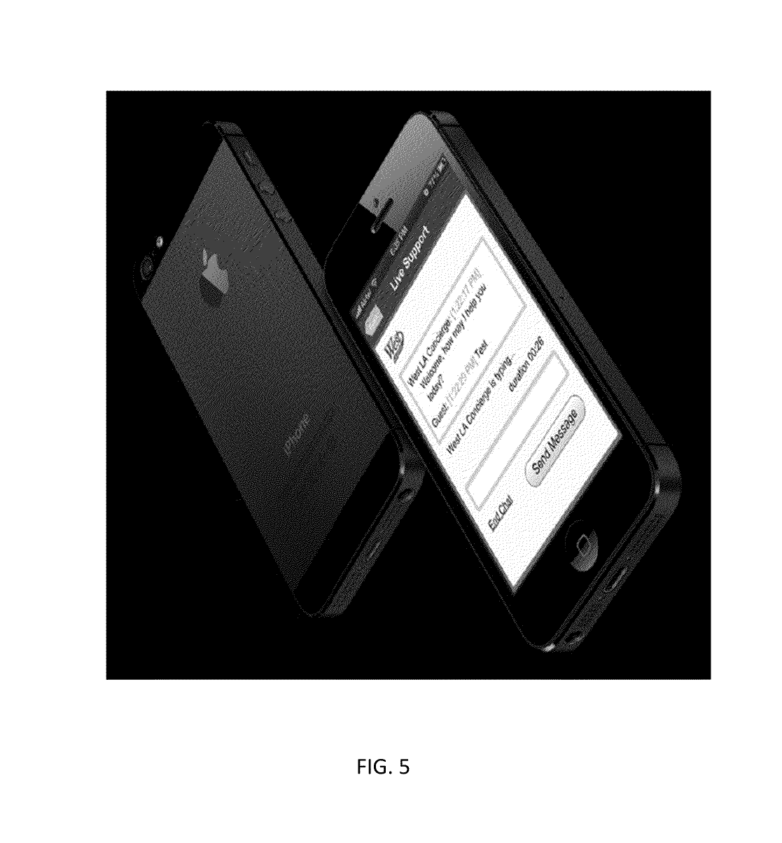

FIG. 5 illustrates a screenshot of a software application on a smartphone, showing live support. Live support can include: text—based live one-to-one communication, FAQ, financial aid questions, assistance with counselor appointments, and assistance with buy books.

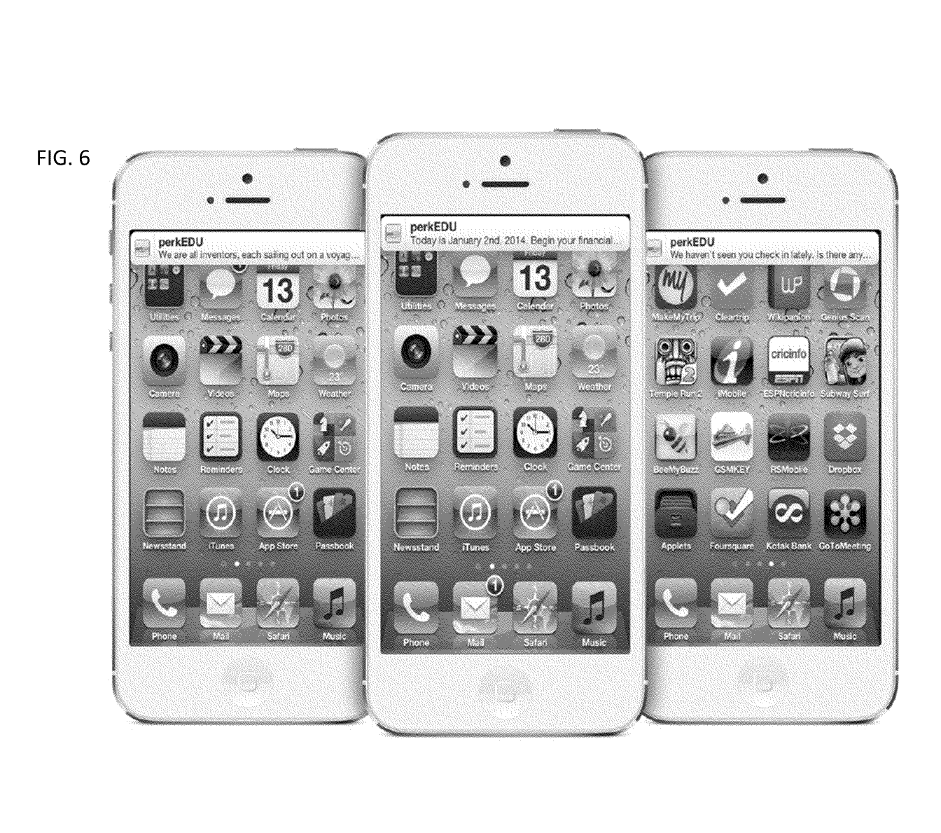

FIG. 6 illustrates a screenshot of a software application on a smartphone. Push messaging can be performed, for example, with motivational messages (right quote at the right time), motivational movie clips, reminder notices (important semester dates), and to ask students if they need help with anything (child care, transportation, jobs, disability support).

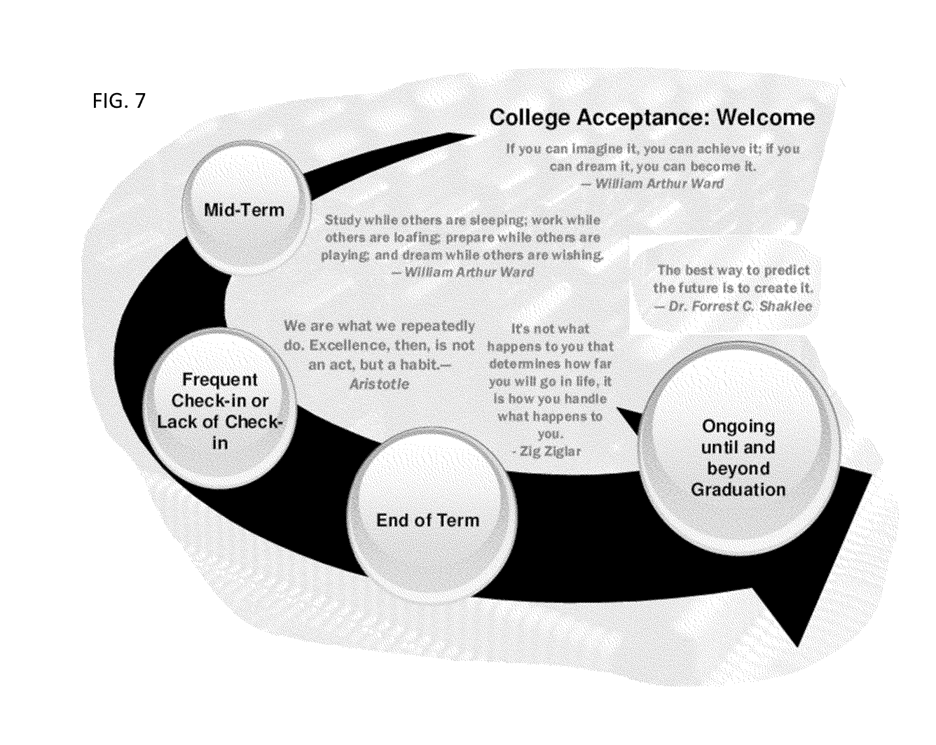

FIG. 7 illustrates an exemplary student life cycle from college acceptance through graduation and beyond.

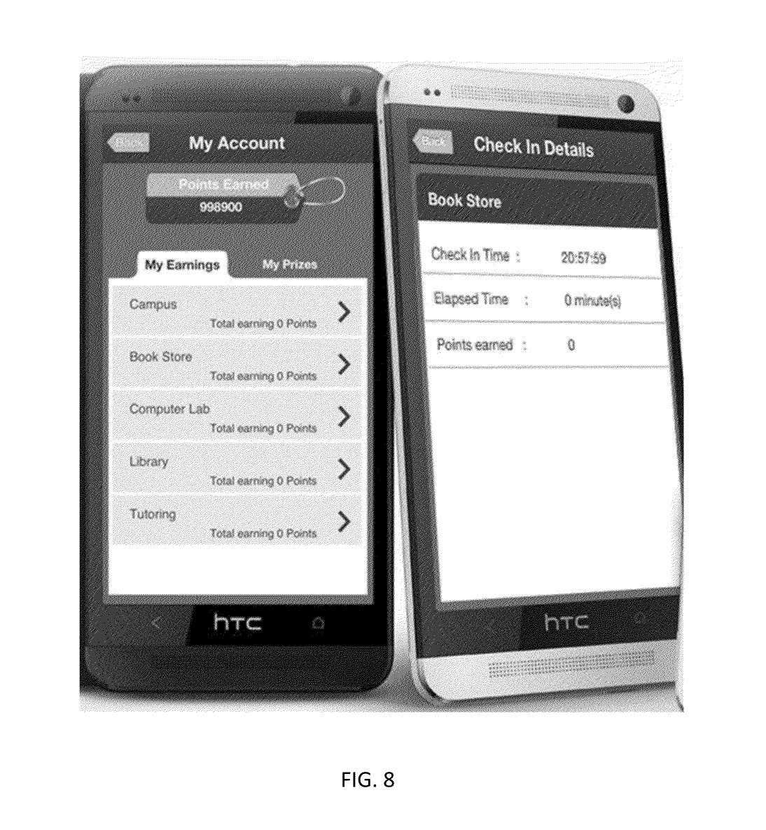

FIG. 8 illustrates a screenshot of a software application on a smartphone, including exemplary check in details at the bookstore, and exemplary account details.

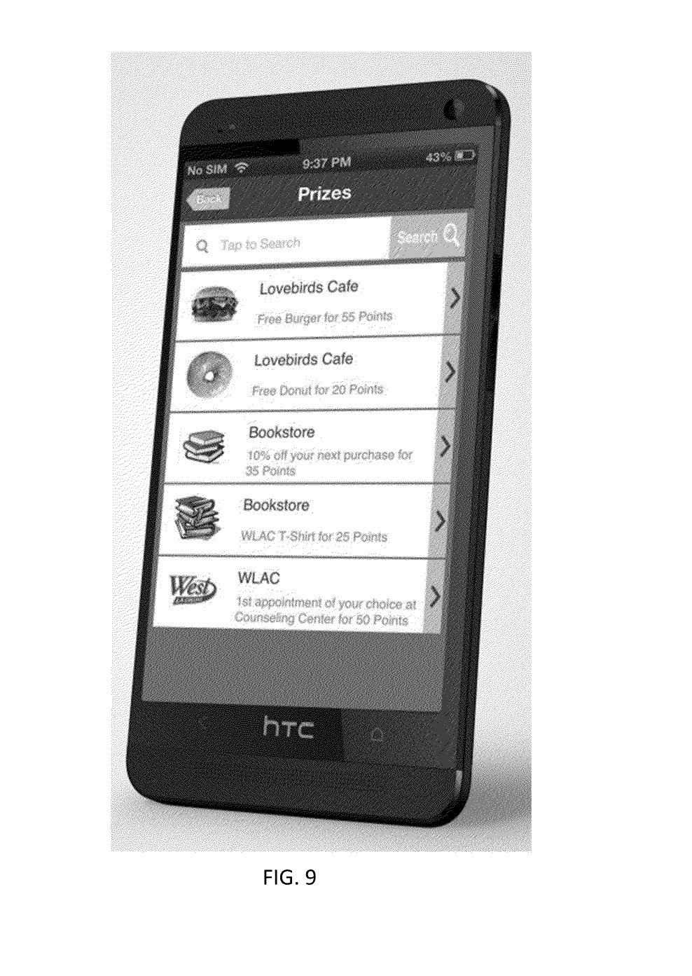

FIG. 9 illustrates a screenshot of a software application on a smartphone, including prizes that can be achieved. For example, a redemption program can:
Incentivize students to make progress toward their educational goal
Give students points for spending time on campus
Use the data of who is not on campus to provide support
Use mobile app technology to intervene (individual push messages)

Example incentives can include lunch with the president, front of the line for counseling, mayor of the campus, signed sports memorabilia from West teams, free t-shirt, discount on books, free school supplies, free coffee, free sandwich, free smoothie, and a free bagel.

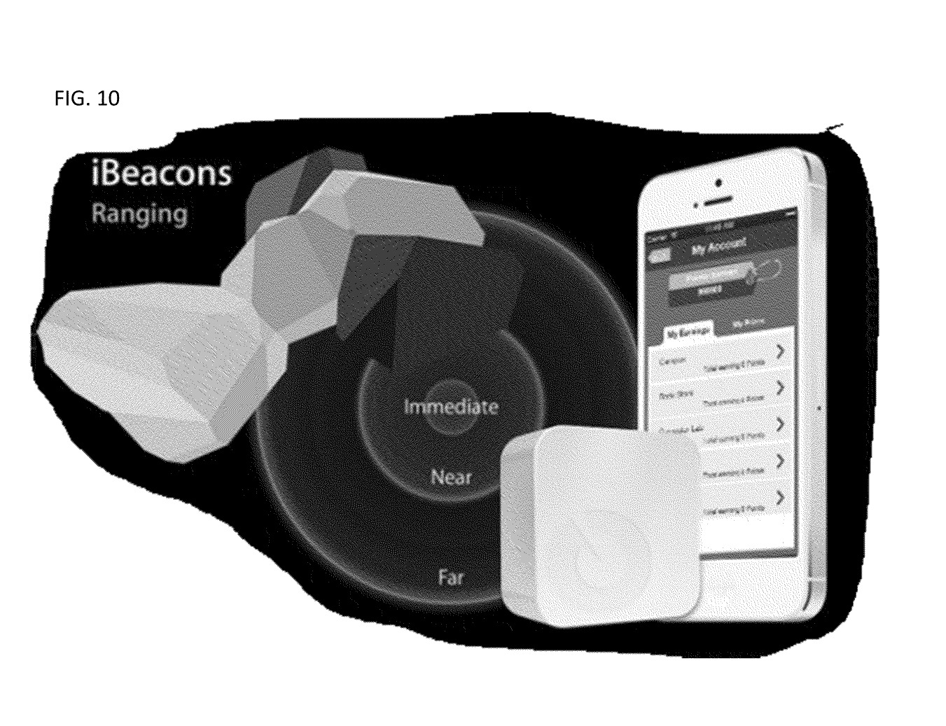

FIG. 10 illustrates new technologies such as iBeacon ranging and other precision micro-location technologies. Apple's new iBeacons feature for iOS7 implements a Bluetooth low energy (BLE) profile for micro-location, enabling a series of new geofencing capabilities, such as pinpoint check-in locations, and push college advertisements at select location.

The data that can be captured includes:
Who's checking in on a regular basis?
Who's not?
Which locations are they checking into?
How much time are they spending in these locations?
What rewards are they redeeming the most?

The data can also be utilized to focus on the students who aren't using the service. Those non-participating students can be asked if they need help and to make recommendations for them.

Preferably students can opt-in to download the software and the college/university will not be giving out any information about students. As described herein, the overall goals are retention, persistence, student engagement, reinforcing positive behaviors, and improving graduation rates.

I claim:

1. A method of identifying the location of subscribers and providing incentives to those subscribers, the method comprising:
a. providing a geolocating means to a plurality of subscribers;
b. tracking the location of the subscribers relative to a fixed geographic area; and
c. providing incentives to the subscribers for remaining within the fixed geographic area.

2. The method of claim 1, wherein the fixed geographic area is an educational campus.
